(19) United States
(12) Patent Application Publication
(10) Pub. No.: US 2020/0253347 A1
(43) Pub. Date: Aug. 13, 2020

(54) LUGGAGE ARRANGEMENT WITH AN INFANT SEAT

(71) Applicants: Sophie Morris, St. Louis, MO (US); Becky Murch, St. Louis, MO (US)

(72) Inventors: Sophie Morris, St. Louis, MO (US); Becky Murch, St. Louis, MO (US)

(21) Appl. No.: 16/859,255

(22) Filed: Apr. 27, 2020

Related U.S. Application Data
(63) Continuation-in-part of application No. 15/810,107, filed on Nov. 12, 2017, now abandoned.

(51) Int. Cl. A45C 9/00; A47D 1/02; B62B 9/24; B62B 7/08; A45C 5/03; A45C 5/14; A45C 13/30

(52) U.S. Cl. CPC A45C 9/00; A47D 1/02; B62B 9/24; B62B 7/08; A45C 2013/306; A45C 5/146; A45C 13/30; A45C 2009/002; A45C 5/03

(57) ABSTRACT

A suitcase has a suitcase body defining a compartment sized and shaped to receive one or more articles. The suitcase body has opposite upper and lower ends and opposite front and rear sides. A seat is connected to the suitcase body. The seat is selectively configurable in a stowed configuration and a deployed configuration in which the seat is arranged to carry a person. A front pair of wheels is disposed adjacent to the lower end and adjacent to the front side. A rear pair of wheels is movable between a first position and a second position relative to the suitcase body. The rear pair of wheels in the first position is disposed adjacent to the lower end and adjacent to the rear side. The rear pair of wheels in the second position is spaced rearward of the lower end and the rear side.

### CROSS-REFERENCE TO RELATED APPLICATION

This application is a continuation-in-part of U.S. application Ser. No. 15/810,107, filed Nov. 12, 2017, which is hereby incorporated by reference in its entirety.

### FIELD

The present disclosure generally relates to a piece of luggage, and more particularly to a suitcase that includes a seat.

### BACKGROUND

Luggage is used for travel purposes and has been modified considerably over recent years. Most conventional luggage includes wheels that enable users to wheel and transport their luggage as needed for easier traveling purposes. Normally, luggage includes wheels with a convertible handle that extends to allow for pulling of the luggage over a flat surface. This wheel and convertible handle arrangement has been implemented on various sizes and pieces of luggage. This arrangement is commonly used and well known in the art. Many travelers travel with their children and need a stroller to transport their child while traveling. As a result, travelers must travel both with luggage and strollers for infant children causing further complication and difficulty in traveling. As a result, it would be advantageous to have a luggage arrangement that includes a convertible infant seat. This convertible infant seat could provide a means to transport the infant along with the luggage in one unique package.

### SUMMARY

The present disclosure relates to a luggage-infant seat arrangement including a luggage compartment; an outer surface on the luggage compartment; a seat compartment on the outer surface; a releasable seat within the seat compartment; and a seatbelt attached to the seat and inner surface of the seatbelt compartment. The seatbelt preferably includes a vertical strap. The luggage compartment also includes a releasable handle with a wheel system that supports the luggage compartment at a vertical angle. The luggage compartment is adapted to function as a stroller in an elevated position and conversely functions as a luggage compartment in a lower position.

In another aspect, a luggage-seat arrangement comprises a luggage body defining at least one luggage compartment. The luggage body has an outer surface. A seat is supported by the luggage body. A safety belt is connected to the seat. A first set of wheels extends below a bottom of the luggage body. A second set of wheels is selectively movable with respect to the luggage body between a stroller position and a non-stroller position. The second set of wheels in the stroller position spaced farther from the first set of wheels than in the non-stroller position. The second set of wheels in the stroller position located to support the luggage body in a reclined orientation.

In another aspect, a suitcase comprises a suitcase body defining a compartment sized and shaped to receive one or more articles. The suitcase body has opposite upper and lower ends and opposite front and rear sides. A seat is connected to the suitcase body. The seat is selectively configurable in a stowed configuration and a deployed configuration in which the seat is arranged to carry a person. A front pair of wheels is disposed adjacent to the lower end and adjacent to the front side. A rear pair of wheels is movable between a first position and a second position relative to the suitcase body. The rear pair of wheels in the first position being disposed adjacent to the lower end and adjacent to the rear side. The rear pair of wheels in the second position being spaced rearward of the lower end.

Other objects and features of the present disclosure will be in part apparent and in part pointed out hereinafter.

### BRIEF DESCRIPTION OF THE DRAWINGS

FIG. 1 is a perspective of a suitcase according to one embodiment of the present disclosure;

FIG. 2 is a front view of the suitcase;

FIG. 3 is a rear view of the suitcase;

FIG. 4 is a front perspective of a suitcase according to another embodiment of the present disclosure, the suitcase in a stroller configuration;

FIG. 5 is a front perspective of the suitcase of FIG. 4, the suitcase in a suitcase configuration;

FIG. 6 is a rear perspective of the suitcase of FIG. 4, the suitcase in the stroller configuration;

FIG. 7 is a rear view of the suitcase of FIG. 4, the suitcase in the suitcase configuration; and

FIG. 8 is an enlarged, fragmentary perspective of a seat of the suitcase of FIG. 4, the seat in a deployed configuration.

Corresponding reference characters indicate corresponding parts throughout the drawings.

### DETAILED DESCRIPTION

The present disclosure relates to a luggage arrangement or suitcase that includes a convertible infant seat along with the outside surface thereof. The luggage arrangement in accordance with the present disclosure has aspects of traditional luggage presently used such as the wheels with an extendable handle extending from the top edge thereof. On the outer surface of the luggage compartment is an infant seat. An infant seat compartment allows for the release of a seat with a safety belt for placement of an infant within the seat and securing with a safety belt. This infant seat allows a user to secure their infant within the seat and thus provides additional function for the luggage.

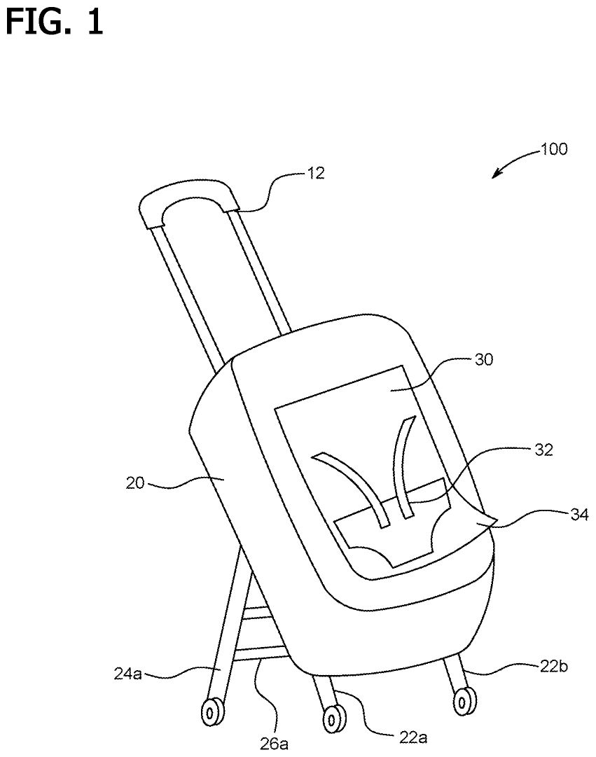

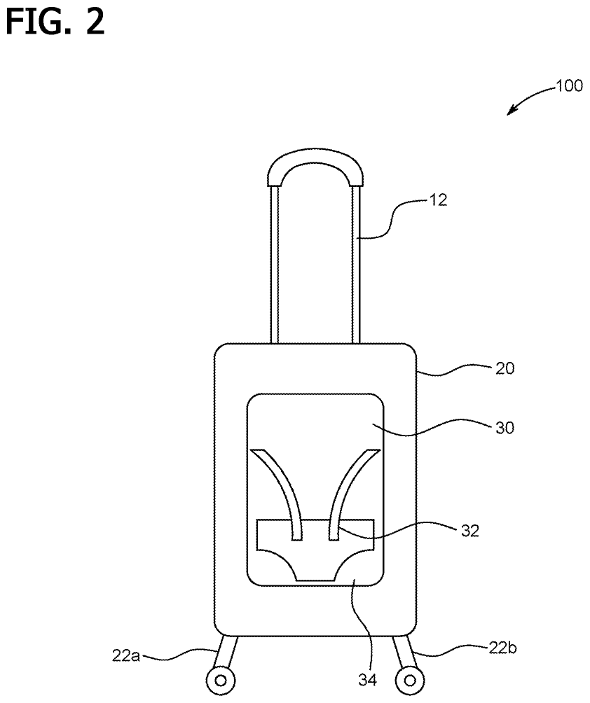

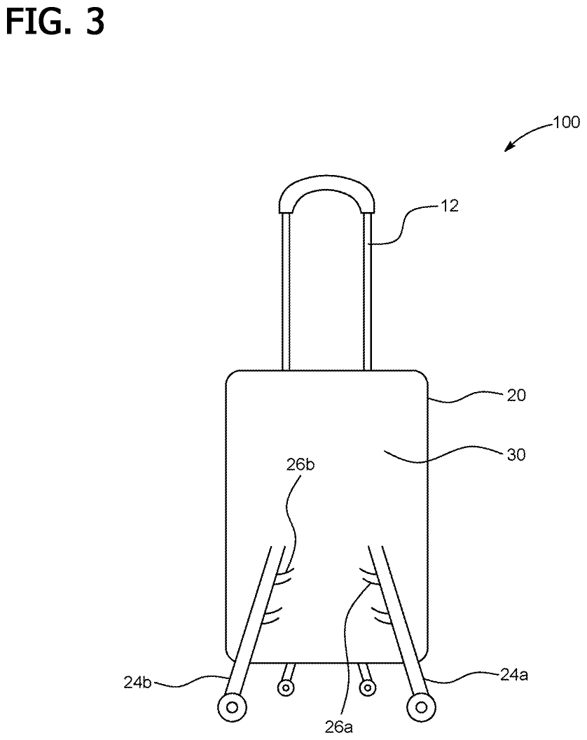

In reference to FIG. 1, a luggage compartment 100 with an infant seat according to present disclosure is depicted. Luggage 20 as shown includes an extendable handle 12 as well as the wheels 22a, 22b, 24a, 24b which extend to support luggage 20. The outer surface of luggage 20 includes a seat compartment 30. The seat compartment 30 holds a seat 34 that is released as shown in FIG. 1. Once this seat 34 is released an infant may be placed in the seat 34 and secured through the use of a safety belt 32. FIG. 2 shows a front view of the luggage 20 showing the seat compartment 30 centered on the luggage 20. FIG. 3 shows a rear view of the luggage 20 where brackets 26a, 26b support the wheels 24a, 24b extending from a back surface of the luggage 20. During use, a user may conceal the seat 34 within the seat compartment 30 until needed and therefore this infant seat 34 has an additional function for luggage 20. The wheels 22a, 22b are at a first length extending from a bottom edge of the luggage 20. The wheels 24a, 24b extend from the back surface of the luggage 20 at a second length longer than the first length of wheels 22a, 22b. The length difference between the first length and second length enable the luggage 20 to be supported at an angle as shown in FIG. 1. The luggage 20 is shown in an elevated or stroller position (e.g., stroller configuration) suitable for operation with a child place in the seat 34. In the elevated or stroller position the luggage 20 functions as a stroller. The wheels 24a, 24b may be released to a lower or non-stroller position (e.g., suitcase configuration) in which the luggage 20 is used in a traditional manner. The lower or non-stroller position moves the wheels 24a, 24b closer to the luggage 20 and the seat 34 remains concealed. The elevated or stroller position enables a user to push the luggage 20 like a baby stroller. In the lower or non-stroller position, the luggage 20 is pulled similar to the prior art luggage.

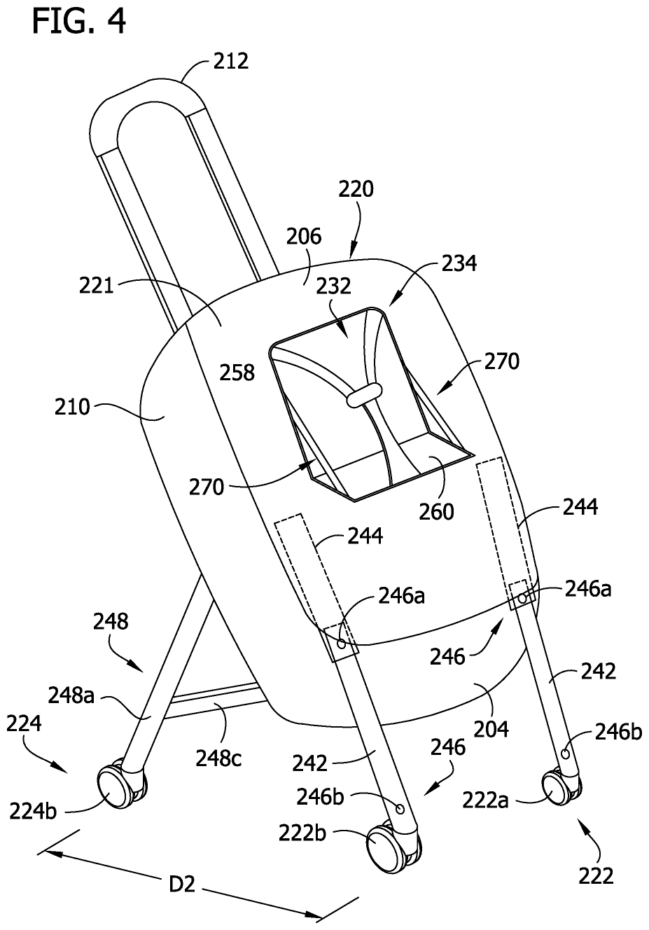

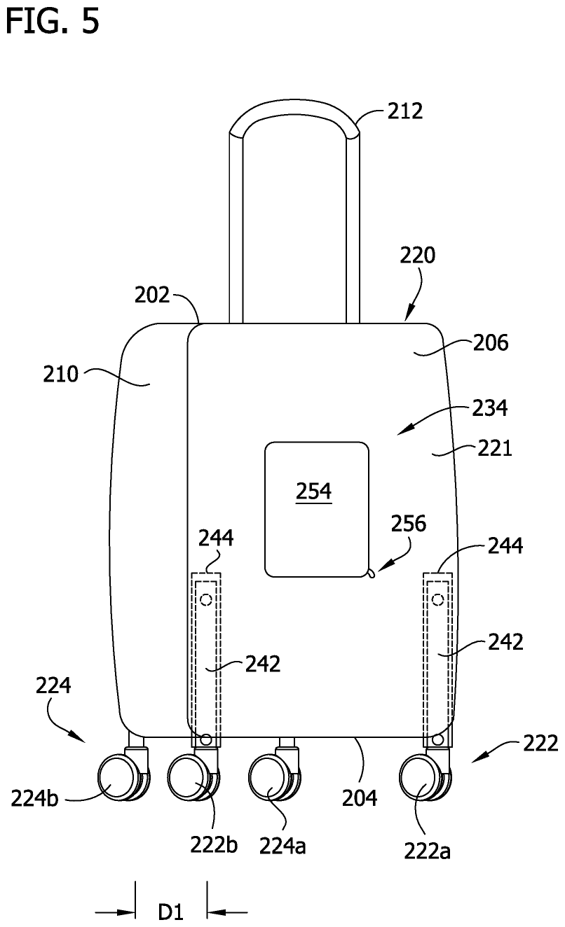

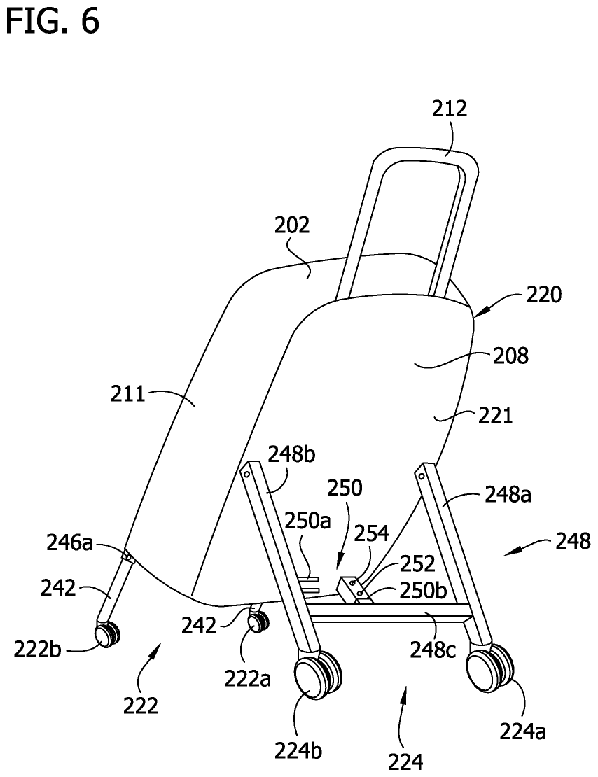

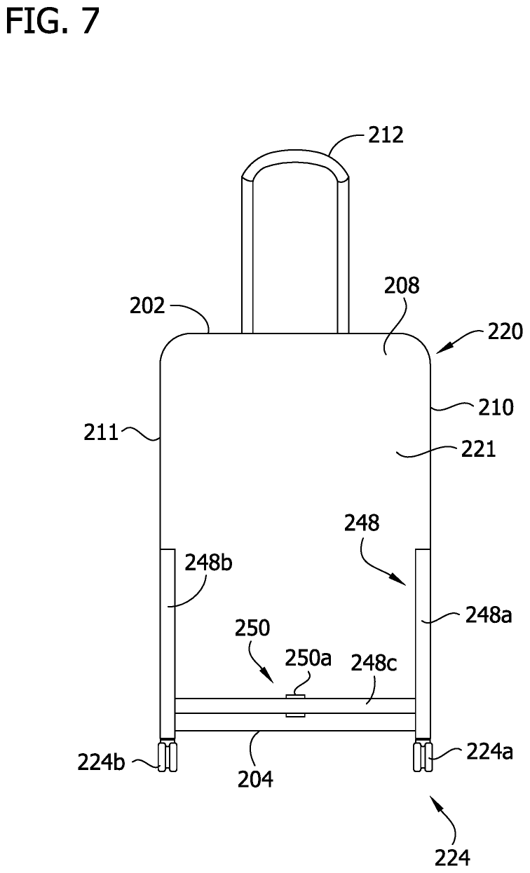

Referring to FIGS. 4-8, another embodiment of the luggage arrangement or suitcase is generally indicated at reference numeral 200. Suitcase 200 is similar to luggage arrangement 100 and, thus, for ease of comprehension, where similar or analogous elements are used, similar reference numbers plus “200” are employed. As explained in more detail below the suitcase 200 includes a seat 234 that can be used to carry a person, such as an infant. The suitcase 200 is configurable in a non-stroller configuration (e.g., FIGS. 5 and 7) and in a stroller configuration (e.g., FIGS. 4 and 6).

The suitcase 200 has a housing or body 220 (e.g., a luggage body or housing or a suitcase body or housing) defining at least one luggage compartment. The at least one luggage compartment is sized and shaped to receive one or more articles, such as clothes, shoes, toiletries, etc., that one may pack in a suitcase. Luggage compartments are well known and thus a detailed description is omitted herein. In the illustrated embodiment, the housing 220 has opposite upper and lower ends 202, 204, opposite front and rear sides 206, 208 and opposite left and right sides 210, 211. The housing 220 has a generally rectangular shape but other shapes are within the scope of the present disclosure. As generally known in the art, the front side 206 can be partially disconnected (e.g., via zipper) from the remainder of the housing to access the one or more luggage compartments. The suitcase 200 includes an extendable handle 212, which extends upward from the upper end 202 when extended (as shown in FIGS. 4-8). The housing 220 has an outer surface 221, which generally corresponds to the outer surface of the suitcase 200.

The suitcase 200 includes a first or front set of wheels 222 and a second or rear set of wheels 224. The front set of wheels 222 includes first and second wheels 222a and 222b. The rear set of wheels 224 includes first and second wheels 224a and 224b. In the non-stroller configuration, the wheels 222a, 222b, 224a, 224b are generally disposed adjacent to the corners of the housing 220 at the lower end 204 of the housing. This maximizes the spacing between the wheels 222a, 222b, 224a, 224b to provide greater stability. For example, in the non-stroller configuration, the suitcase 200 may be rolled on a support surface with all of the wheels 222, 224 in rolling engagement with the support surface. In the illustrated embodiment, in the non-stroller configuration, the front wheels 222 and rear wheels 224 are disposed entirely below the lower end 204 (e.g., bottom) of the housing 220, with the front wheels adjacent the front side 206, and the rear wheels 224 adjacent the rear side 208. Alternatively, the wheels could extend beyond the lower rend 204 without being entirely below the lower end, without departing from the scope of the present disclosure. Desirably, the wheels 222a, 222b, 224a, 224b are swivel wheels, which are able to turn in any direction.

Referring to FIGS. 4 and 5, the first set of wheels 222 is movable between a retracted position (FIG. 5) and an extended position (FIG. 4), relative to the housing 220. In the retracted position, the first set of wheels 222 is generally adjacent the lower end 204 of the housing 220 and generally adjacent the front side 206 of the housing (e.g., generally adjacent to the bottom of the housing). In the extended position, the first set of wheels 222 is farther from the lower end 204 of the housing and the front side 206 of the housing than in the retracted position (e.g., farther away from the bottom of the housing). Each wheel 222a, 222b is connected to an extender 242 (specifically, an end thereof) to facilitate selective movement of the wheels between the retracted and extended positions. Each extender 242 is movable relative to the housing 220 to move the respective wheel 222a, 222b (e.g., the first set of wheels 222) between the extended and retracted positions. Each extender 242 is coupled to a guide 244 in the housing 220. In the illustrated embodiment, each guide 244 comprises an extender housing defining a compartment to receive the extender 242. The extender housings 244 include an open end through which the extenders 242 extend. In the retracted position of the extender 242 (FIG. 5), most if not all (broadly, a majority) of the extender 242 is disposed within the compartment of the extender housing 244 and concealed within the housing 220. In the extended position (FIG. 4), most if not all (broadly, a majority) of the extender 242 is disposed outside the compartment of the extender housing 244 and outside the housing 220. In the illustrated embodiment, the extender 242 slides relative to the extender housing 244 to move toward the extended and retracted positions. In this manner, the extender 242 may be considered (e.g., comprises) a telescoping arm. For example, in one embodiment, the extender 242 is a shaft and the extender housing 244 is a hollow shaft, the extender sliding within the hollow shaft extender housing to move between the extended and retracted positions. Other configurations of the extender and extender housing are within the scope of the present disclosure.

The suitcase 200 may include a front wheel retainer 246 to retain the first set of wheels 222 in at least one of the retracted or extended positions. Desirably, the front wheel retainer 246 retains the front set of wheels 222 in both the extended and retracted positions. In the illustrated embodiment, each extender 242 has an upper front wheel retainer 246a and a lower front wheel retainer 246b supported thereon. The upper front wheel retainer 246a retains or secures the wheels 222a, 222b in the extended position and the lower front wheel retainer 246b retains or secures the wheels 222a, 222b in the retracted position. In the illustrated embodiment, the upper and lower front wheel retainers 246a, 246b include spring loaded push pins configured to extend through an opening adjacent the lower end of the extender housing 244 to secure the extender 242 in either the extended position or retracted positions. To move the extender 242 from the extended or retracted position, a user pushes the push pin out of the opening to permit the extender 242 to move relative to the extender housing 244. The extender 242 is moved until either the upper or lower push pin 246a, 246b becomes aligned with the opening in the extender housing 244. Once the push pin 246a, 246b is aligned with the opening, the spring pushes the push pin into the opening, securing the extender 242 in either the extended or retracted position. Other types of retainers are within the scope of the present disclosure.

Referring to FIGS. 4-7, the rear set of wheels 224 is movable between a first or non-stroller position (FIGS. 5 and 7) and a second or stroller position (FIGS. 4 and 6), relative to the housing 220. In the non-stroller position, the rear set of wheels 224 is generally adjacent the lower end 204 of the housing 220 and generally adjacent the rear side 208 of the housing (e.g., generally adjacent to the bottom of the housing). In the stroller position, the rear set of wheels 224 is farther from the lower end 204 of the housing 220 and the rear side 208 of the housing than in the first position (e.g., farther away from the bottom of the housing). In particular, in the stroller position, the rear set of wheels 224 is spaced rearward of the lower end 204 of the housing 220 and the rear side 208 (e.g., spaced rearward of the non-stroller position). In the second position, the rear set of wheels 224 is spaced farther from the first set of wheels 222 than in the first position. For example, in the illustrated embodiment, the front and rear sets of wheels 222, 224 are separated by a first distance D1 when the rear set of wheels is in the non-stroller position (FIG. 5) and are separated by a second distance D2 when the rear set of wheels is in the stroller position (FIG. 4), with the second distance being greater than the first distance (this is the case whether the front set of wheels is in the extended or retracted positions). In the non-stroller position, the rear set of wheels 224 is located to support the housing 220 in a generally upright orientation (e.g., a longitudinal axis extending between the upper and lower ends 202, 204 is generally vertical). In the stroller position, the rear set of wheels 224 is located to support the housing 220 in a reclined orientation (e.g., the longitudinal axis or the front side 206 is at a reclined angle relative to vertical). Accordingly, the orientation of the suitcase 200 can be set by selectively moving the rear set of wheels 224 to the non-stroller or stroller position.

The rear set of wheels 224 are coupled to a bracket or frame 248 of the suitcase 200. The frame 248 is movable relative to the housing 220 to move the rear set of wheels 224 to the non-stroller and stroller positions. The frame 248 includes opposite first and second side members or arms 248a and 248b interconnected by a third member or arm 248c. In the illustrated embodiment, each wheel 224a, 224b is connected to a lower end of one of the side members 248a, 248b , and the frame 248 is pivotably connected to the housing 220 to enable the rear set of wheels 224 to move to the non-stroller and stroller positions. The upper ends of the side members 248a, 248b are pivotably coupled to the hosing 220 such as with pins (e.g., bolts). This permits the rear set of wheels 224 to pivot with respect to the housing 220 to move between the non-stroller and stroller positions. Other ways of movably coupling the rear set of wheels 224 to the housing 220 are within the scope of the present disclosure.

The suitcase 200 may include a rear wheel retainer 250 (broadly, one or more rear wheel retainers) to retain the rear set of wheels 224 in at least one of the non-stroller or stroller positions. Desirably, the rear wheel retainer 250 retains the rear set of wheels 224 in both the non-stroller and stroller positions. In the illustrated embodiment, the suitcase 200 includes a first rear wheel retainer 250a and a second rear wheel retainer 250b (FIG. 6). The first rear wheel retainer 250a retains or secures the rear set of wheels 224 in the non-stroller position. The second rear wheel retainer 250b retains or secures the rear set of wheels 224 in the stroller position. In other embodiments, a single rear wheel retainer may secure the second set of wheels 224 in both the first and second positions. In the illustrated embodiment, the first rear wheel retainer 250a comprises a clip. The clip 250a is mounted on the rear side 208 of the housing 220 and clips (e.g., snap fits) to the frame 248 (specifically, the third member 248c) when the frame is in the non-stroller position to hold the frame and second set of wheels 224 in the non-stroller position. The suitcase 200 may include more than one clip 250a.

In the illustrated embodiment, the second rear wheel retainer 250b is a rigid member or arm having one end coupled to the housing 220 (e.g., rear side 208) and another end connected to the frame 248 (specifically, the third member 248c). The connection between the rigid member 250b and the housing 220 and/or the connection between the rigid member and the frame 248 may be releasable. Releasing the rigid member 250 allows the frame 248 and second set of wheels 224 to move between the non-stroller and stroller positions. Moreover, the connection between the rigid member 250b and the housing 220 and/or the connection between the rigid member and the frame 248 may be pivotable to allow the rigid member to be stored in a recess of the housing and/or frame when the frame and second set of wheels 224 are in the non-stroller position. In one embodiment, the second rear wheel retainer 250b may be configured to set the second set of wheels 24 in different locations (e.g., different stroller position locations) relative to the housing 220. In this manner, the degree or amount of incline of the suitcase 200 can be set as desired by the user. The farther the location of the stroller position is from the housing 220, the greater the amount of incline will be for the suitcase 200. In the illustrated embodiment, the rigid member 250b includes at least two telescoping portions movable relative to each another to adjust the length of the rigid member. Adjusting the length of the rigid member 250b adjusts the distance between the second set of wheels 224 and the housing 220 when the rear wheels are in the stroller position, thereby adjusting the amount of incline of the suitcase 200. One of the telescoping portions can include a push pin 252, as described above, that can be aligned with one opening 254 of a plurality of openings in the other telescoping portion. By selecting which opening 254 of the plurality of openings the push pin 252 is aligned with and extends into, the length of the rigid member 250b can be set and changed as desired. Other configurations of the rear wheel retainers are within the scope of the present disclosure. For example, the second rear wheel retainer 250 could comprise a flexible strap (e.g., two straps, one for each frame member 248a, 248b ) extending between the housing 220 and frame 248 with a buckle to adjust the length of the strap, and thereby the location of the second set of wheels 224 in the second position.

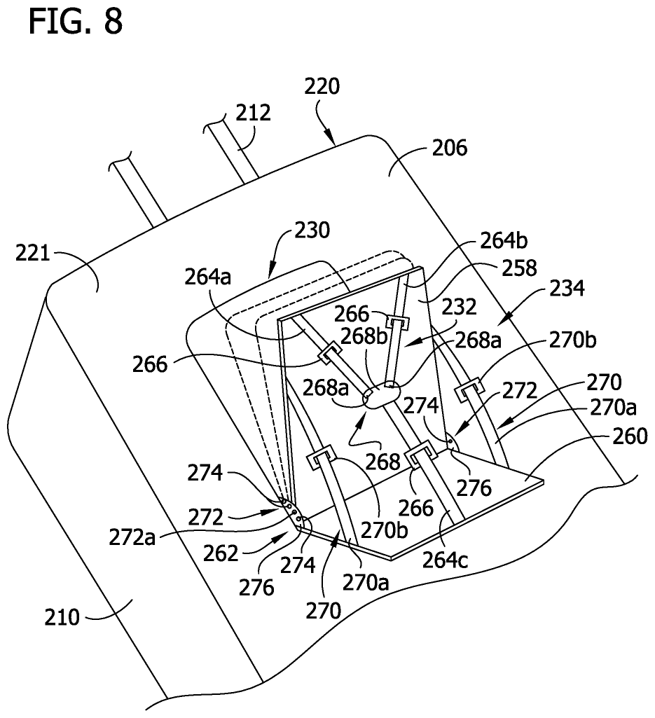

Referring to FIGS. 4, 5 and 8, the seat 234 (e.g. infant seat) of the suitcase 200 is connected to the housing 220 to be supported by the housing. Specifically, the seat 234 is generally mounted on the outer surface 221 of the housing 220. In the illustrated embodiment, the seat 234 is mounted on the front side 206 of the housing 220, although other mounting locations on the housing 220 are within the scope of the present disclosure. The seat 234 is movable between a stowed configuration (FIG. 5) and a deployed configuration (FIGS. 4 and 8). In the stowed configuration, the seat 234 is stowed within a seat pocket or compartment 230. The seat pocket 230 may include a flap or cover 254 with a zipper 256 extending along the left and right sides and top of the seat pocket to open and close the seat pocket (FIG. 5). The bottom of the seat pocket 254 is connected to the housing 220 of the suitcase 200 such that the pocket is openable by pivoting about the connection of the connection to the housing to deploy the seat. In the deployed configuration, the seat 234 is arranged to carry a person (e.g., infant). The seat 234 includes a back 258 and a base 260. The back 258 is configured to support the back of the person sitting in the seat 234 and the base 260 is configured to support the buttocks of the person. The seat 234 may include a safety belt or harness 232 to secure the person in the seat. In the illustrated embodiment, the safety harness 232 includes a first strap 264a, a second strap 264b, and a third strap 264c. As shown in FIG. 8, each strap 264a, 264b, 264c includes at least one buckle 266 to adjust the length of the respective straps in order to conform the safety harness 232 to the size of the person sitting in the seat 234. The third strap 264c is connected to the base 260 at one end and has a female connector 268b of a quick release connector 268 attached to the other end. The third strap 264c generally extends toward the back 258. The first and second straps 264a, 264b are connected to the back 258 at one end and have a male connector 268a of the quick release connector 268 attached to the other end. The first and second straps 264a, 264b extend toward the female connector 268b (and base 260) from generally opposite sides of the back 258. The male connectors 268a are inserted into the female connector 268b to secure the straps 264a, 264b, 264c together. As shown in FIG. 8, when the straps 264a, 264b, 264c are connected together by the quick release connector 268, the safety harness 232 has a generally Y-shape. Other configurations of the safety belt or harness are within the scope of the present disclosure.

The seat 234 is adjustable to conform to persons of different shapes and sizes. The base 260 is movable with respect to the back 258 (and the housing 220). In one embodiment, a hinge 262 (FIG. 8) connects the base 260 to the back 258 and/or the housing 220. This enables the base 260 to be folded up against the back 258 in the stowed configuration and allows the position (e.g., angle) of the base relative to the back to be adjusted and set in the deployed configuration. The seat 234 includes at least one support 270 configured to maintain or secure the position of the base 260 relative to the back 258. The at least one support 270 is also adjustable or reconfigurable to enable the position of the base 260 to be adjusted relative to the back 258 and permit the base to move to the stowed configuration. In the illustrated embodiment, the seat 234 includes two supports 270. The supports 270 are disposed on opposite sides of the seat 234. Each support 270 includes a strap 270a and a buckle 270b. Each strap 270a has one end connected to the back 258 and another end connected to the base 260. By adjusting the length of the straps 270a with the buckles 270b, the position of the base 260 relative to the back 258 (and housing 220) can be adjusted or set. The straps 270a also permit the base 260 to be moved to the stowed position. The supports 270 are distinct from the safety harness 232. In the stowed position, the supports 270 and safety harness 232 are disposed within the seat pocket 230.

The back 258 of the seat 234 may also be movable with respect (e.g., relative) to the housing 220. The hinge 262 may also connect the back 258 to the housing 220 and permit the back to pivot or rotate relative to the housing. This allows the positon (e.g., angle) of the back 258 relative to the housing 220, and by extension the overall position or orientation of the seat 234 relative to the housing, to be adjusted and set in the deployed configuration. Various exemplary positions of the back 258 are indicated by dashed lines in FIG. 8. The seat 234 includes at least one back retainer 272 configured to maintain or secure the position of the back 258 relative to the housing 220. In the illustrated embodiment, the seat 234 includes two back retainers 272, one on generally each side of the seat. The back retainers 272 include a spring loaded push pin 272a, as described above, configured to extend through an opening 274 of a plurality of openings in a retainer holder 276 to secure the back 258 in position relative to the housing 220. By selecting which opening 274 of the plurality of openings in the retainer holder 276 the push pin 272a is aligned with and extends into, the position of the back 258 can be set and changed as desired. Collectively, the push pin 272a and the retainer holder 276 may be considered the back retainer 272. Other types of retainers are within the scope of the present disclosure. Releasing the back retainer 272 permits the back 258 to move to the stowed configuration, although, desirably, the seat 234 can move to the stowed configuration with the back 258 in at least one of the positions set by the back retainer 272. This way the user does not have to release and reset the back retainer 258 every time the user moves the seat 234 between the stowed and deployed configurations.

As is now apparent, the suitcase 200 can have one configuration (e.g., a suitcase or non-stroller configuration or arrangement) where the suitcase functions as a conventional piece of luggage and another configuration (e.g., a stroller configuration or arrangement) where the same suitcase can function as a stroller. The suitcase configuration of the suitcase 200 is shown in FIG. 5. In the suitcase configuration, the front and rear sets of wheels 222, 224 are located to support the housing 220 on a support surface (not shown), such as a floor, at the same time for rolling on the support surface with the housing in a generally upstanding or vertical orientation. In the suitcase or non-stroller configuration, the front set of wheels 222 is in the retracted position, and the rear set of wheels 224 is in the non-stroller position. Moreover, the first and second sets of wheels 222, 224 are spaced apart by the first distance D1, and the seat 234 is in the stowed configuration.

The stroller configuration of the suitcase 200 is shown in FIG. 4. In the stroller configuration, the first and second sets of wheels 222, 224 are located to support the housing 220 on the support surface at the same time for rolling on the support surface with the housing in a generally reclined orientation. In the stroller configuration, the second set of wheels 224 is in the second position, and the first set of wheels 222 is in the extended position. This lifts the bottom of the housing 220 (e.g., the rear edge margin of the lower end 204) upward, away from the support surface so the bottom of the housing 220 does not contact (e.g., is spaced part from) the support surface when in the stroller configuration. In this configuration, the seat 234 is in the deployed configuration. The seat 234 is entirely supported by the housing 220 and is spaced apart from the floor. This allows the suitcase 200 to be moved while supporting a person in the seat 234. In the stroller configuration, the first and second sets of wheels 222, 224 are spaced apart by the second distance D2, which is greater than the first distance D1.

The handle 212 can be extended or retracted in the suitcase configuration and the stroller configuration. Desirably, the handle 212 is extended in both the suitcase configuration and the stroller configuration to provide the user with an easily accessible location at which to grab the suitcase 200 and push/pull the suitcase.

From the suitcase configuration (FIG. 5), a user can reconfigure the suitcase 200 to the stroller configuration, as shown in FIG. 4. To change the suitcase 200 to the stroller configuration, the user moves the front set of wheels 222 to the extended position, the rear set of wheels 224 to the stroller position, and the seat 234 to the deployed configuration. The user extends the extenders 242, as described above, to move the front set of wheels 222 to the extended position. Similarly, the user pivots or rotates the frame 248 away from the housing 220, as described above, to move the rear set of wheels 224 to the stroller position. To move the seat 234 from the stowed position to the deployed position, the user unzips the zipper 256 to open the seat pocket 230 and then rotates the base 260 downward about the hinge 262. Once the supports 270 stop the rotation of the base 260 relative to the housing 220, the seat 234 is ready to be used. If needed, the user can select the position or orientation of the back 258 (broadly, the seat 234) relative to the housing 220, as described above, to account for the incline of the housing, size and shape of the person in the seat, and/or comfort preferences. To change the suitcase 200 back to the suitcase configuration, the user generally reverses the steps above. The user moves the seat 234 back to the stowed configuration by rotating the base 260 upward toward the back 258 and then closes the seat pocket 230 using the zipper 256. The user retracts the extenders 242, as described above, to move the front set of wheels 222 to the retracted position. Similarly, the user pivots or rotates the frame 248 toward the housing 220, as described above, to move the rear set of wheels 224 to the first position. It is understood these steps could be performed in other orders. Moreover, other configurations of the suitcase 200 are possible beside the suitcase configuration or the stroller configuration. For example, in one arrangement the front set of wheels 222 is in the extended position and the rear set of wheels 224 is in the stroller position, with the seat 234 in the stowed position.

The foregoing descriptions of specific embodiments of the present disclosure are presented for purposes of illustration and description. They are not intended to be exhaustive or to limit the disclosure to the precise forms disclosed, and obviously many modifications and variations are possible in light of the above teaching. The exemplary embodiments were chosen and described to explain the principles of the disclosure and example practical applications, to thereby enable others skilled in the art to best utilize the disclosure and various embodiments with various modifications as are suited to the particular use contemplated.

It will be appreciated that various aspects of the disclosure described herein can be modified without departing from the scope of the appended claims. For example, features may be omitted or have other forms without departing from the scope of the present disclosure.

When introducing elements of the present disclosure or the preferred embodiment(s) thereof, the articles “a”, “an”, “the”, and “said” are intended to mean that there are one or more of the elements. The terms “comprising”, “including”, and “having” are intended to be inclusive and mean that there may be additional elements other than the listed elements.

As various changes could be made in the above constructions, products, and methods without departing from the scope of the disclosure, it is intended that all matter contained in the above description and shown in the accompanying drawings shall be interpreted as illustrative and not in a limiting sense.

What is claimed is:

1. A luggage-seat arrangement comprising:
a luggage body defining at least one luggage compartment, the luggage body having an outer surface;
a seat supported by the luggage body;
a safety belt connected to the seat;
a first set of wheels generally disposed below a bottom of the luggage body;
a second set of wheels, the second set of wheels being selectively movable with respect to the luggage body between a stroller position and a non-stroller position, the second set of wheels in the stroller position spaced farther from the first set of wheels than in the non-stroller position, the second set of wheels in the stroller position located to support the luggage body in a reclined orientation.

2. The luggage-infant seat arrangement according to claim 1, wherein the first set of wheels is movable between a retracted position in which the first set of wheels is disposed generally adjacent to the bottom of the luggage body and an extended position in which the first set of wheels is farther away from the bottom of the luggage body than in the retracted position.

3. The luggage-infant seat arrangement according to claim 2, wherein the wheels of the first set of wheels are connected to extenders, the extenders selectively extendable with respect to the luggage body to move the first set of wheels between the retracted and extended positions.

4. The luggage-infant seat arrangement according to claim 1, wherein when the second set of wheels are in the non-stroller position, the first and second sets of wheels are engageable with a support surface at the same time for rolling on the support surface while supporting the suitcase body in a generally upstanding orientation, and, when the second set of wheels are in the second position, the first and second sets of wheels are engageable with the support surface at the same time for rolling on the support surface while supporting the suitcase body in said reclined orientation.

5. The luggage-infant seat arrangement according to claim 1, wherein the second set of wheels are pivotable with respect to the luggage body to move the second set of wheels between the non-stroller and stroller positions.

6. The luggage-infant seat arrangement according to claim 1, wherein the seat includes a back and a base movable relative to the back, the infant seat including at least one strap extending from the back to the base to maintain a position of the base relative to the back.

7. The luggage-infant seat arrangement according to claim 6, wherein the back of the seat is movable relative to the luggage body.

8. A suitcase comprising:
a suitcase body defining a compartment sized and shaped to receive one or more articles, the suitcase body having opposite upper and lower ends, and opposite front and rear sides;
a seat connected to the suitcase body, the seat selectively configurable in a stowed configuration and a deployed configuration in which the seat is arranged to carry a person;
a front pair of wheels disposed adjacent to the lower end and adjacent to the front side;
a rear pair of wheels movable between a first position and a second position relative to the suitcase body, the rear pair of wheels in the first position being disposed adjacent to the lower end and adjacent to the rear side, the rear pair of wheels in the second position being spaced rearward of the lower end.

9. The suitcase according to claim 8, wherein the front pair of wheels is selectively movable with respect to the suitcase body between a retracted position and an extended position, the front pair of wheels in the retracted position being disposed adjacent to the lower end and adjacent to the front side, the front pair of wheels in the extended position being farther from the lower end than in the retracted position.

10. The suitcase according to claim 9, wherein the wheels of the front pair of wheels are connected to extenders, wherein the extenders are movable with respect to the suitcase body to move the front pair of wheels between the retracted and extended positions.

11. The suitcase according to claim 10, wherein each extender comprises a telescoping arm.

12. The suitcase according to claim 10, further comprising a front wheel retainer configured to retain the front pair of wheels in at least one of the retracted position or the extended position.

13. The suitcase according to claim 10, wherein the suitcase is configurable in a suitcase configuration and a stroller configuration, wherein in the suitcase configuration the front pair of wheels is in the retracted position and the rear pair of wheels is in the first position, and, in the stroller configuration the front pair of wheels is in the extended position and the rear pair of wheels is in the second position, a distance between the front pair of wheels and the rear pair of wheels being greater when the suitcase is in the stroller configuration than when the suitcase is in the suitcase configuration.

14. The suitcase according to claim 10, wherein, when the front pair of wheels are in the retracted position and the rear pair of wheels are in the first position, the front and rear pairs of wheels are located to support the suitcase body on a support surface at the same time for rolling on the support surface with the suitcase body in a generally upstanding orientation, and, when the front pair of wheels are in the extended position and the rear pair of wheels are in the second position, the front and rear pairs of wheels are located to support the suitcase body on the support surface at the same time for rolling on the support surface with the suitcase body in a generally reclined orientation.

15. The suitcase according to claim 10, further comprising a rear wheel retainer configured to retain the rear pair of wheels in at least one of the first position or the second position.

16. The suitcase according to claim 9, wherein the seat includes a safety belt and includes a back and a base movable relative to the back and to the suitcase body, the seat including at least one support different from the safety belt to maintain a position of the base relative to the back.

17. The suitcase according to claim 16, wherein the at least one support comprises straps on opposite sides of the seat, each strap extending from the back to the base.

18. The suitcase according to claim 16, wherein the back of the seat is movable relative to the suitcase body.

19. The suitcase according to claim 18, wherein the seat further includes a back retainer configured to maintain a position of the back relative to the suitcase body.

20. The suitcase according to claim 13, wherein in the suitcase configuration the seat is in the stowed configuration and in the stroller configuration the seat is in the deployed configuration.
